(19) United States
(12) Patent Application Publication
(10) Pub. No.: US 2026/0132067 A1
(43) Pub. Date: May 14, 2026

(54) DEPLOYABLE RESILIENT INSTALLATION WATER PURIFICATION AND TREATMENT SYSTEM AND METHOD

(71) Applicant: United States of America as Represented by The Secretary of The Army, Alexandria, VA (US)

(72) Inventors: Clint B. Smith, Chantilly, VA (US); Ilea A. Diaz-Lluberes, Annandale, VA (US); Michael J. Anderson, Washington, DC (US); Jose A. Mattei-Sosa, Vicksburg, MS (US); Syed Osman A. Tirmizi, Chantilly, VA (US); Daniel F. Mesheske, Stafford, VA (US); Kurtis T. Daniels, LaGrange, KY (US); Steven Combest, Crestwood, KY (US); Mark Hogg, Louisville, KY (US); James A. Goodrich, Union, KY (US)

(21) Appl. No.: 19/383,504

(22) Filed: Nov. 7, 2025

Related U.S. Application Data
(60) Provisional application No. 63/718,501, filed on Nov. 8, 2024.

(51) Int. Cl. C02F 9/00; C02F 1/00; C02F 1/32; C02F 1/44; C02F 1/46

(52) U.S. Cl. CPC C02F 9/00; C02F 1/001; C02F 1/325; C02F 1/441; C02F 1/46; C02F 2201/005; C02F 2201/008; C02F 2201/009; C02F 2209/40

(57) ABSTRACT

In one embodiment, a deployable water treatment system is configured to be placed on a mobile trailer for treating water. The system comprises: a UV-C disinfection system to apply ultraviolet (UV) light to the water; an electro-chlorination apparatus using electricity to convert the water into a sodium hypochlorite solution; particulate filtration modules for particulate filtration of the water; a granular activated carbon (GAC) filtration device to filter the water; and a water quality analysis system. The water quality analysis system includes a water sensor flow cell having sensors to measure water quality parameters of the water to produce data, a data processor to digitize the data for the water quality parameters, and a transmitter to transmit the data from the data processor to a flow controller to be used to control a flow of the water to recirculate the water though the deployable water treatment system or not.

### CROSS-REFERENCE TO RELATED APPLICATIONS

The present application is a nonprovisional of and claims the benefit of U.S. Provisional Ser. No. 63/718,501 , entitled DEPLOYABLE RESILIENT INSTALLATION WATER PURIFICATION AND TREATMENT SYSTEM, which is incorporated herein in its entirety by reference.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### BACKGROUND

### Field of the Invention

The present invention relates to water purification and treatment and, more specifically, to a compact, deployable water purification and treatment system that is operable under multiple optional power resources.

### Description of the Related Art

This section introduces aspects that may help facilitate a better understanding of the invention. Accordingly, the statements of this section are to be read in this light and are not to be understood as admissions about what is prior art or what is not prior art.

Traditional methods of providing deployable water purification and treatment include technologies such as the Tactical Water Purification System (TWPS), the Lightweight Water Purifier (LWP), and the Lightweight Water Purification System (LWPS).

### SUMMARY

Embodiments of the invention provide a deployable resilient installation water purification and treatment system that is compact, ruggedized, and operable with multiple power sources. The system provides novel improvements and modifications to utilizing a high concentration bleach generator apparatus, system and method and/or a water quality analysis system and method, in the water purification and treatment system.

The present invention was developed to address the desire for a compact system that incorporates sensor manifolds such as the WaterDOG (Water Diagnostics Operations Gear) water diagnostics manifold or similar separation (e.g., U.S. Pat. No. 10,288,595) and incorporates an electro-chlorinator such as the high concentration bleach generator system (e.g., U.S. Pat. No. 10,077,197). Embodiments of the invention provide the ability to operate the compact and ruggedized water purification and treatment system under multiple optional power sources (AC sources and DC sources).

According to an aspect the present invention, a deployable water treatment system is configured to be placed on a mobile trailer for treating water. The system comprises: a UV-C (Ultraviolet-C) disinfection system to apply ultraviolet (UV) light to the water; an electro-chlorination apparatus using electricity to convert the water into a sodium hypochlorite solution; particulate filtration modules for particulate filtration of the water; a granular activated carbon (GAC) filtration device to filter the water; and a water quality analysis system. The water quality analysis system includes a water sensor flow cell having sensors to measure water quality parameters of the water to produce data, a data processor to digitize the data for the water quality parameters, and a transmitter to transmit the data from the data processor to a flow controller to be used to control a flow of the water to recirculate the water though the deployable water treatment system or not.

In accordance with another aspect, a deployable water treatment system for treating water comprises: a trailer bed; a water treatment system and a water quality analysis system disposed in the trailer bed. The water treatment system includes a UV-C disinfection system to apply ultraviolet (UV) light to the water; an electro-chlorination apparatus using electricity to convert the water into a sodium hypochlorite solution; particulate filtration modules for particulate filtration of the water; and a granular activated carbon (GAC) filtration device to filter the water. The water quality analysis system includes a water sensor flow cell having sensors to measure water quality parameters of the water to produce data, a data processor to digitize the data for the water quality parameters, and a transmitter to transmit the data from the data processor to a flow controller to be used to control a flow of the water to recirculate the water though the deployable water treatment system or not.

In accordance with another aspect of the invention, a method comprises: placing a water treatment system and a water quality analysis system in a trailer bed; directing a flow of the water into the water treatment system, which includes a UV-C disinfection system to apply ultraviolet (UV) light to the water; an electro-chlorination apparatus using electricity to convert the water into a sodium hypochlorite solution; particulate filtration modules for particulate filtration of the water; and a granular activated carbon (GAC) filtration device to filter the water; analyzing a water quality of the water exiting the water treatment system to measure water quality parameters of the water to produce data, to digitize the data for the water quality parameters using a data processor, and to transmit the data from the data processor to a flow controller; and determining, based on the data transmitted to the flow controller, whether to recirculate the water exiting the water treatment system into the water treatment system for additional treatment or to direct water from a water source into the water treatment system for treatment.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a block diagram illustrating an example of a Deployable Resilient Installation Water Purification and Treatment System (DRIPS).

FIG. 2A is a top plan view of a lightweight tactical trailer. FIG. 2B is a side elevational view thereof. FIG. 2C is a front elevational view thereof.

FIG. 3 is a schematic view of a filter configuration of the DRIPS filtering system.

FIG. 4 is a diagram illustrating an example of an inverter battery system with vehicle/generator charging.

FIG. 5 is a diagram illustrating an example of addressing power needs of 1,500 watts per hour.

FIG. 6 is a block diagram illustrating another example of a battery-generator-inverter system.

FIG. 7 shows an example of a trailer setup for the DRIPS.

FIG. 8 shows an example of a fluid flow configuration for the DRIPS.

FIG. 8A shows a GAC filter bypass valve and a GAC filter bypass path for the GAC filter.

FIG. 8B shows an electro-chlorinator bypass valve and an electro-chlorinator bypass path for the electro-chlorinator.

FIG. 8C shows a UV lamp bypass valve and a UV lamp bypass path for the UV lamp.

FIG. 8D is a block diagram illustrating an example of water flow and control through a water quality analysis system and the DRIPS.

FIG. 9 is a diagram illustrating an example of fluid flow for filling a water tank in the DRIPS to a desired level.

FIG. 10 is a diagram illustrating an example of fluid flow recirculation in the DRIPS to increase Cl levels and contact time with UV.

FIG. 11 is a flow diagram illustrating an example of various processes of operation of the DRIPS.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Embodiments of the invention provide a compact and ruggedized water purification and treatment system operable under multiple optional power sources. In one example, a Deployable Resilient Installation Water Purification and Treatment System (DRIPS) is a compact system that incorporates sensor manifolds such as the WaterDOG (Water Diagnostics Operations Gear) water diagnostics manifold or similar separation (e.g., U.S. Pat. No. 10,288,595) and incorporates an electro-chlorinator such as the high concentration bleach generator system (e.g., U.S. Pat. No. 10,077,197).

The systems, methods, and apparatus of the invention include novel improvements and/or modifications upon, or utilization of, High Concentration Bleach Generator Apparatus, System and Method of Use, U.S. Pat. No. 10,077,197, and/or Water Quality Analysis System and Method, U.S. Pat. No. 10,288,595. The entire disclosures of these two references are incorporated herein by reference. The invention discloses a compact and ruggedized water purification and treatment system operable under multiple optional power sources.

The DRIPS provides a small, compact class of water purification and treatment system compared to the larger Army TWPS. It is similar to the Army LWP and USMC LWPS, but provides enhanced features described herein.

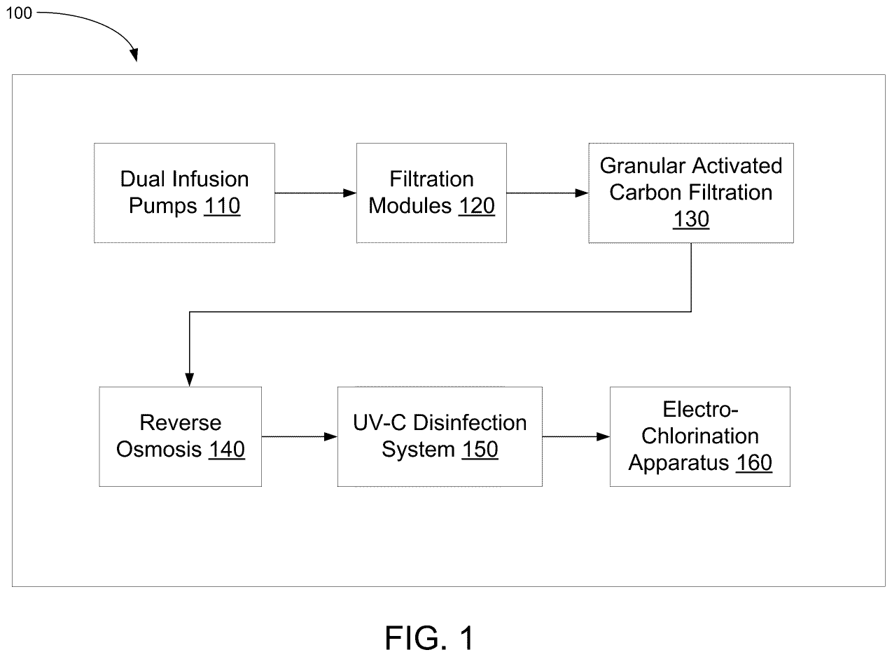

FIG. 1 is a block diagram illustrating an example of a Deployable Resilient Installation Water Purification and Treatment System (DRIPS) 100. It utilizes reverse osmosis 140 as part of the treatment train as well as modular filtration modules 120 for particulate filtration. Furthermore, the DRIPS 100 has a UV-C disinfection system 150, an electro-chlorination apparatus 160, dual infusion pumps 110, and granular activated carbon filtration device 130 for further water quality polishing. The DRIPS 100 may be covered by Chemical Agent Resistant Coating (CARC) protective paint coatings.

The dual infusion pumps 110 provide parallel paths filtration. The modular filtration modules 120 are individual, self-contained filters or units that are linked together to form flexible and scalable filtration systems. The granular activated carbon (GAC) filtration device 130 passes the water through a column packed with GAC granules. This form of activated carbon is effective in removing a wide range of contaminants, including organic compounds, chlorine, taste, and odor-causing substances. The reverse osmosis unit 140 uses a semi-permeable membrane to remove contaminants by forcing water through it under pressure. The process filters out impurities such as lead, arsenic, chlorine, and PFAS to produce purified water called permeate. The UV-C disinfection system 150 uses ultraviolet light to kill or inactivate germs by damaging their DNA and RNA. The electro-chlorination apparatus 160 uses electricity to convert salt water (brine or seawater) into a sodium hypochlorite solution, which is a strong disinfectant. This on-site process generates chlorine without needing to transport, store, or handle dangerous bulk chemicals, making it a safer and often more cost-effective method for water disinfection and biofouling prevention.

### Mobile Trailer for System Footprint

The DRIPS 100 has a footprint that fits, for example, in the bed of an Army Lightweight Tactical Trailer (LTT, i.e., M1102), approximately 2,000 pounds, and is ruggedized to include metal fixtures. Other trailers, wagons, or towed vehicles, as well as a vehicle having a bed/deck, can be used.

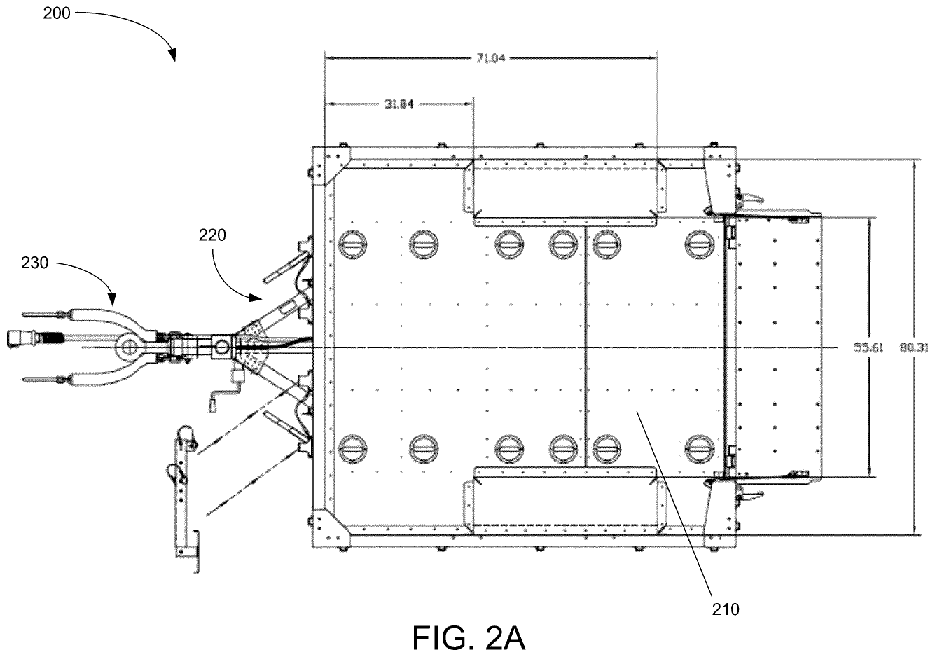

FIG. 2A is a top plan view of a lightweight tactical trailer 200. FIG. 2B is a side elevational view thereof. FIG. 2C is a front elevational view thereof.

The trailer 200 includes a trailer bed/deck 210 on wheels 212. The bed/deck 210 provides a cargo floor and can be made of durable materials like steel or aluminum plate. Tie-down anchors are often integrated to secure cargo. The trailer 200 may have high, reinforced side panels and a rear gate that can fold down to act as a ramp. Robust, heavy-duty locking solutions are used to secure cargo and ensure safety during transport. Towing components include a tongue/drawbar 220 (the front-most part of the frame that extends out to the tow vehicle) and a coupler or hitch 230 which connects the trailer's tongue to the tow vehicle's hitch. A jack stand 240 is a retractable or foldable leg mounted on the tongue used to support the trailer and level it when detached from a tow vehicle. A heavy-duty, weather-resistant canvas or vinyl tarp/cover may be used to protect the cargo from rain, dust, and sun exposure.

### Dual Flow Filter Configuration

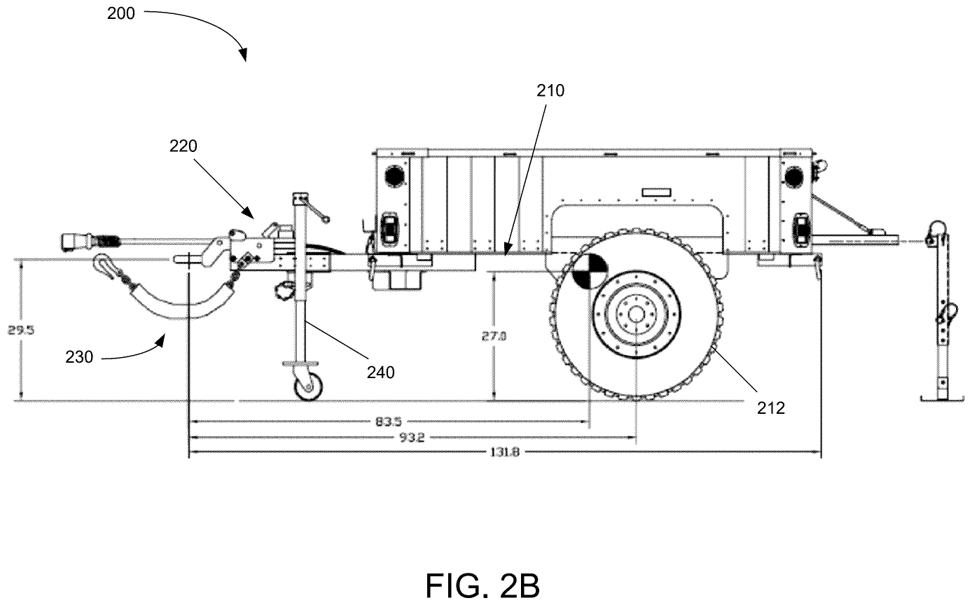

FIG. 3 is a schematic view of a filter configuration 300 of the DRIPS filtering system. The lower arrow 310 shows the direction of the incoming pre-filtered water into the DRIPS for additional micro-filtration of sediment and algal removal around 50 to 100 micrometers in size. A directional valve 320 splits the flow into two parallel paths 330, 332 to provide a dual flow possibility by doubling up the flow path for filtration with a 100-micrometer filter 340 and a 50-micrometer filter 350 for filtration in each parallel path. If one side gets full and/or clogged, that side can be shut down and cleaned, while still keeping one of the flows open to maintain water production. Once one side is cleaned, then the other side can be closed and cleaned to be ready for use. This process helps with maintaining continuous water production and precludes shutting down the system to clean the initial pre-filtration, so as to maintain constant operations. Currently, the water on wheels (WOW) cart does not provide such a feature, while the DRIPS does. In this embodiment, the modular particulate filtration modules 120 include the first filter 340 and the second filter 350.

### Multiple Optional Power Sources

The DRIPS 100 can be operated via multiple optional power sources including, but not limited to, power supplied from military generators as well as electrical 110 Volt-AC plug(s), a dual fuel generator (propane or gasoline)/optional JP-8/F-24 fuel generator, for example, or power adaptable with military generator sources such as a 5-10 kW generator, for example, and power from microgrid solar which may be storable until needed.

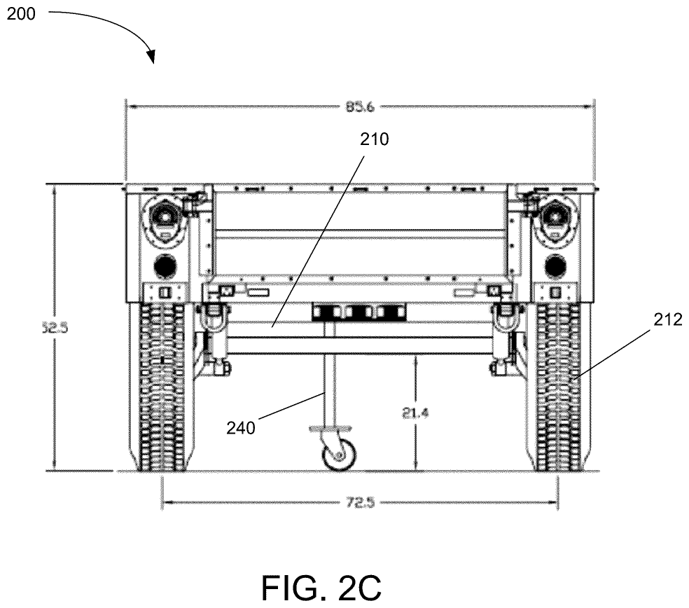

FIG. 4 is a diagram illustrating an example of an inverter battery system 400 with vehicle/generator charging. An inverter/charger 410 is configured to receive AC input from an AC source such as a utility power 420 or a utility generator 422 and DC input from a DC source such as a solar panel 430 which provides DC input via a solar controller 432 and a battery bank 434 to the inverter 410. The inverter 410 provides AC output to a vehicle 440 such as an RV and home appliances 442. An LCD remote control 450 may be used to control operation of the inverter 410.

In one embodiment, the inverter battery system 400 includes a 4000 W DC 24V split phase pure sine wave inverter with charger. The inverter battery system 400 further includes a 24V 100 AH LIFEPO4 deep cycle lithium battery with Bluetooth, self-heating, and IP65. The IP65 is an Ingress Protection (IP) rating that indicates the system is protected against dust and water. The inverter battery system 400 also includes a battery (e.g., Power Queen 24V 200 Ah deep cycle lithium battery), a 50′ slave cable jumper cable, a NATO receptacle with box, and a DC battery-to-battery charger.

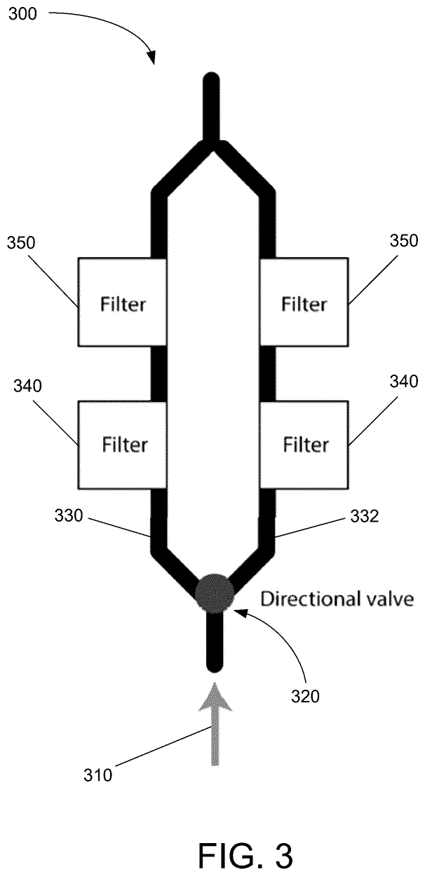

FIG. 5 is a diagram 500 illustrating an example of addressing power needs of 1,500 watts per hour. A DC battery-to-battery charger 24V-24V 35A 510 provides DC input to batteries of a microgrid 520 via a cable (e.g., 2/0 copper). The microgrid 520 may include 3×24 volt 300 amp LIPO4 batteries connected in parallel for 600 amps with total power of 14,000 watt hours. The microgrid 520 provides DC input to an inverter 530 via a cable (e.g., 2/0 copper). A wire 540 (e.g., 12 gauge copper) connects the inverter 530 to a breaker 550 (e.g., 20 Amp 115V breaker) which is coupled to AC outlets 560 (e.g., 115V outlets).

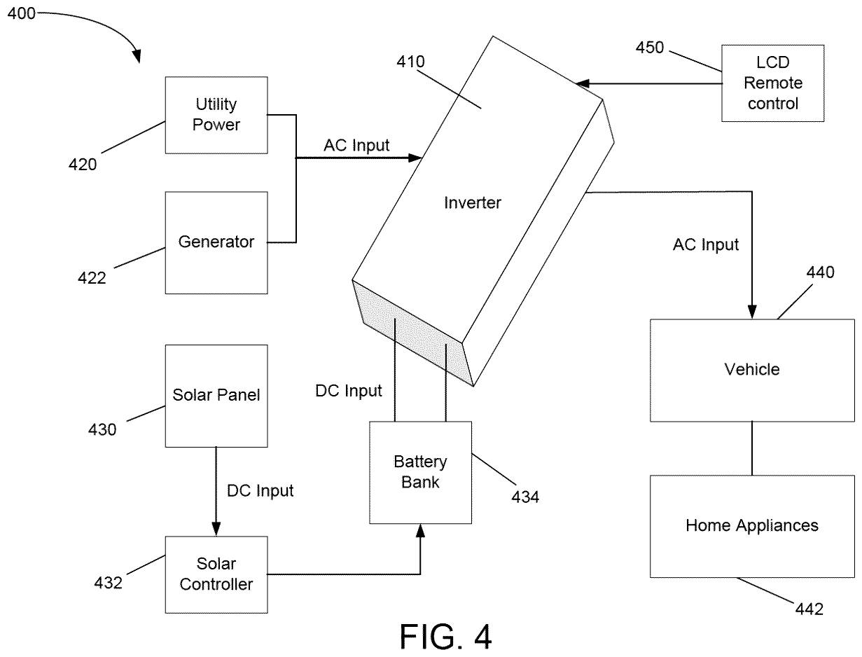

FIG. 6 is a block diagram illustrating another example of a battery-generator-inverter system 600. Some of the components are similar to those in FIG. 4 and FIG. 5. An inverter/charger (hybrid) 610 receives input from a generator (AC) 620 via a rectifier (internal AC to DC) 622 and from a battery bank (DC) 630 via a charge controller (battery) 632. A transfer switch (automatic/manual) 640 can be used to switch between the generator 620 and the battery bank 630. The inverter/charger 600 supplies AC to AC loads 650.

### Trailer Setup for Deployable Resilient Installation Water Purification and Treatment System (DRIPS)

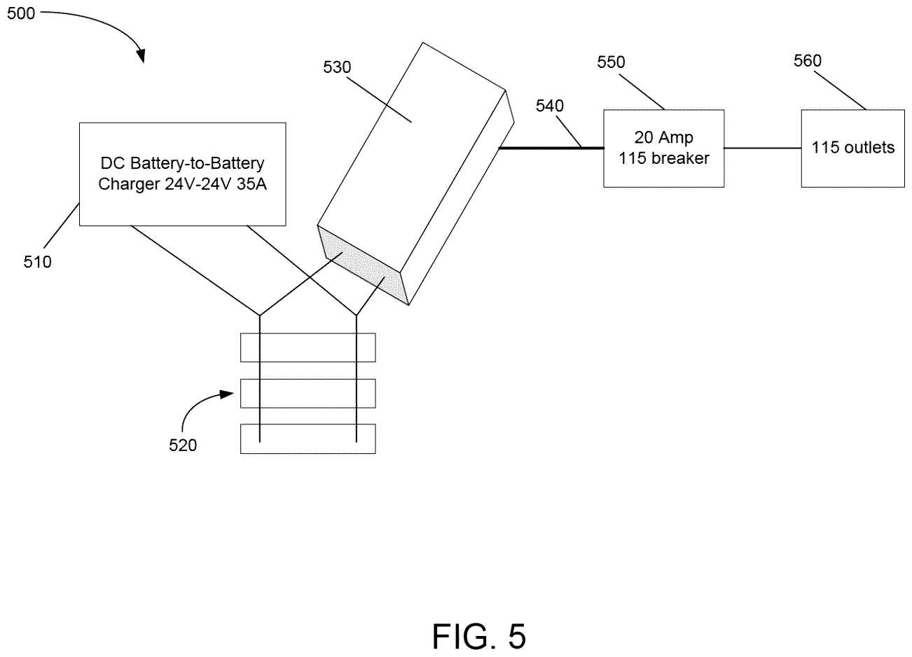

FIG. 7 shows an example of a trailer setup 700 for the DRIPS 100. Trailer railings 710 are provided on the bed/deck 210 of the trailer 200. Batteries 720 are placed on the bed/deck 210 and covered by a batteries cover 722. Trailer ramps 730 placed between a folded down rear gate 732 and the ground are used to move the DRIPS 100 onto the bed/deck 210. For easy transport, the DRIPS 100 may have wheels that slide to move the DRIPS 100 up to the bed/deck 210 or down to the ground. Tie-down anchors can be used to secure the DRIPS 100 to the bed/deck 210. A trailer cover 740 is used to cover the DRIPS 100 disposed on the bed/deck 210 for protection.

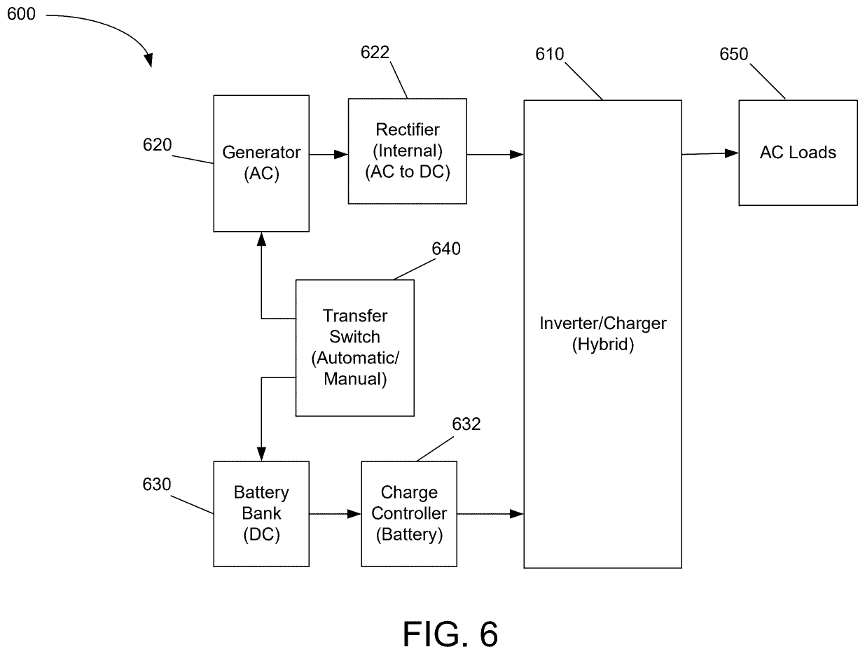

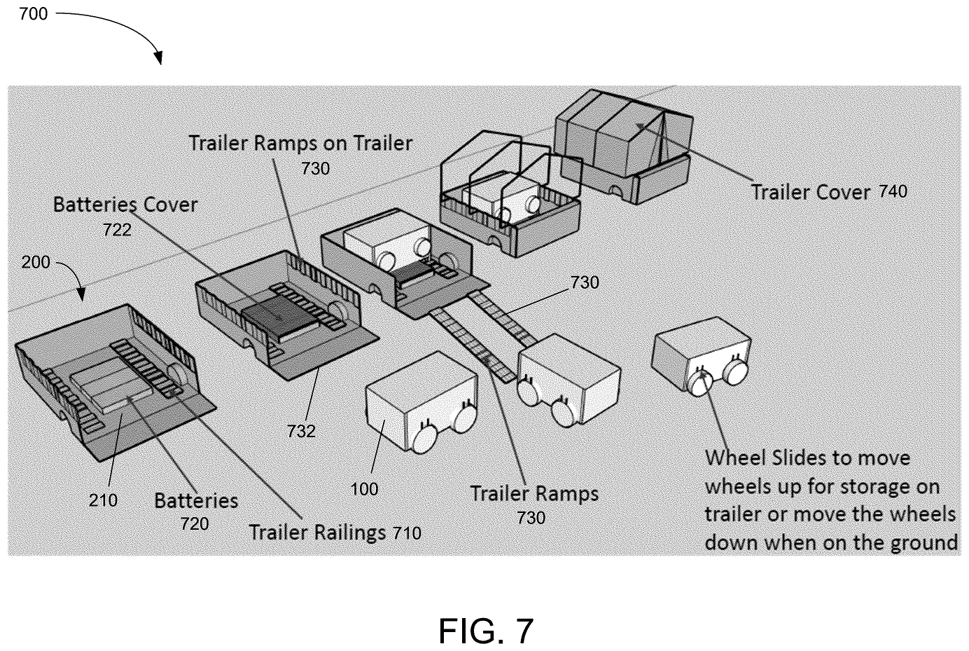

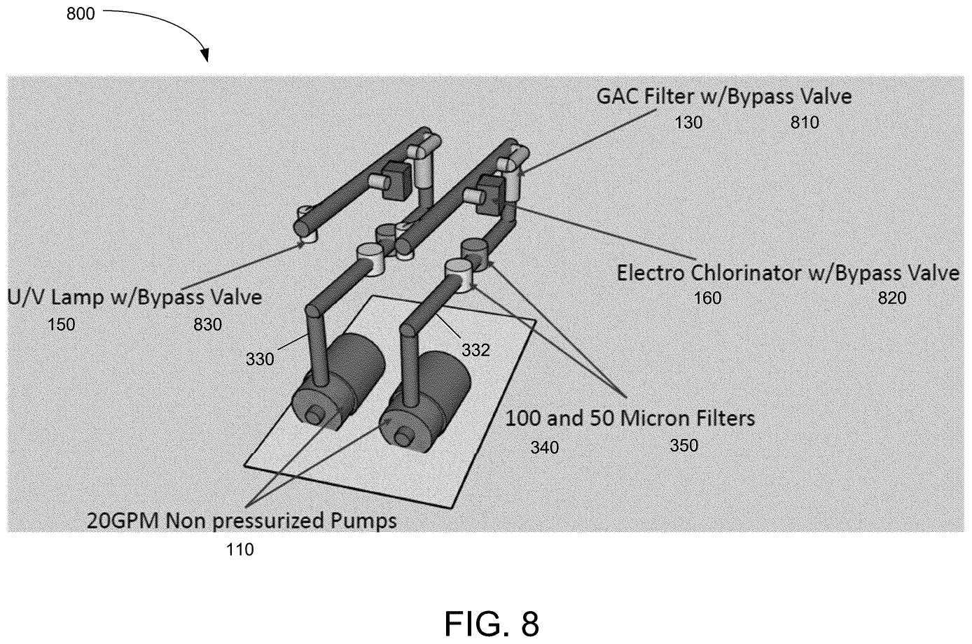

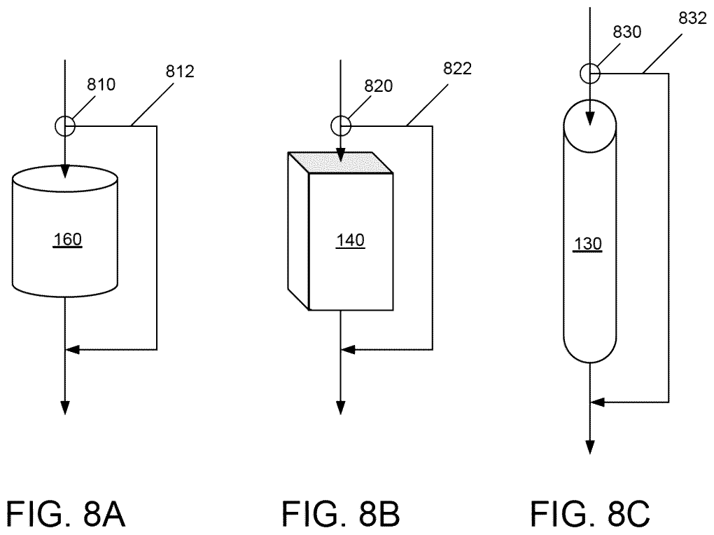

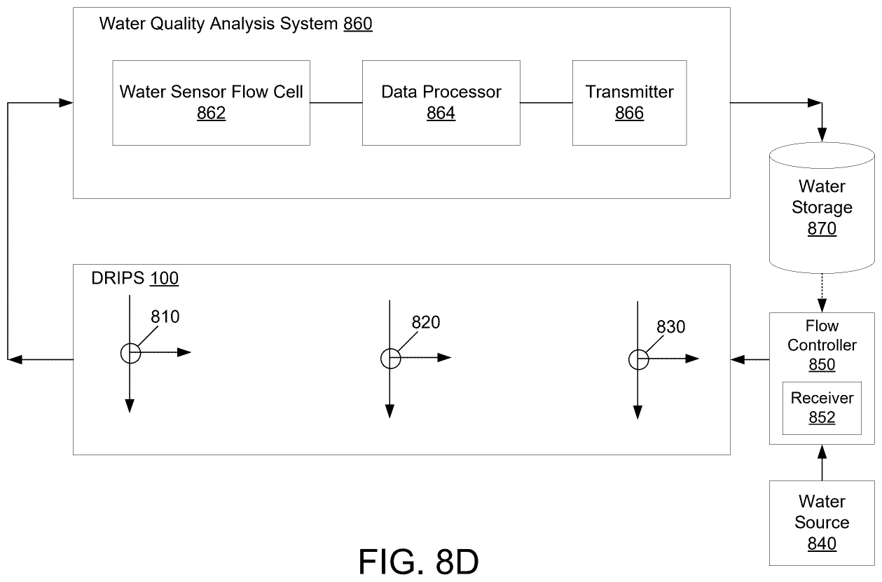

FIG. 8 shows an example of a fluid flow configuration 800 for the DRIPS 100. In this example, the dual infusion pumps 110 are 20 GPM non-pressurized pumps. In each path of the two parallel flow paths 330, 332, the flow from the corresponding pump 110 passes through a 100 micron filter 340 and a 50 micron filter 350 to the GAC filter or GAC filtration device 130. A GAC filter bypass valve 810 provides a GAC filter bypass path 812 (FIG. 8A) to bypass the GAC filter 130 as an option. The flow continues to the electro-chlorinator 160. An electro-chlorinator bypass valve 820 provides an electro-chlorinator bypass path 822 (FIG. 8B) to bypass the electro-chlorinator 160 as an option. The flow then continues to the UV lamp 150. A UV lamp bypass valve 830 provides a UV lamp bypass path 832 (FIG. 8C) to bypass the UV lamp 150.

The decision to bypass a device depends on the water quality being treated and the finished quality goal or end use. For example, re-chlorinating the treated water using the electro-chlorinator 160 to increase the chlorine residual to improve disinfection would not require the GAC filter 130 which can thus be bypassed. The process can be reversed once the required chlorine residual and contact time is achieved by bringing the GAC filter 130 back on-line and bypassing the electro-chlorinator 160 and the UV lamp 150 to remove some of the excess chlorine and make the water more palatable. Furthermore, a high quality source water would not need the RO unit 140 or the GAC unit 130 which can thus be by-passed.

FIG. 8D is a block diagram illustrating an example of water flow and control through a water quality analysis system and the DRIPS 100. A water source 840 supplies water to the DRIPS 100. A flow controller 850 can be used to control the water flow into the DRIPS 100. The flow controller 850 includes a receiver 852 to receive data used to control the water flow. After the water is treated by the DRIPS 100, it flows into a water quality analysis system 860 for analysis. The water analysis system 860 includes a water sensor flow cell 862, a data processor 864, and a transmitter 866. In alternative embodiments, the placement of the water quality analysis system 860 may be changed. In one example, the water quality analysis system 860 may be positioned to analyze the water stored in the water storage 870. In another example, the water quality analysis system 860 may be positioned between the water source 840 and the DRIPS 100 to analyze the water of the water source 840.

U.S. Pat. No. 10,288,595 describes an example of the water quality analysis system 860. The water quality analysis system 860 is capable of making multiple simultaneous measurements of different water quality parameters and saving or transmitting this data for analysis. A housing surrounds the water sensor flow cell 862 and the data processor 864. The flow cell 862 may include a manifold body incorporating a water channel through which a stream of water flows. The water channel may be a single-path channel or a multi-path channel. Multiple probe bores within the flow cell 862 house different sensor probes used to measure different water quality parameters of the stream. The data processor 864 receives and digitizes data for the different water quality parameters. The sensor probes continuously measure multiple parameters (i.e., two or more parameters) of the volume of water and continuously transmit data values of the measured water quality parameters to the data processor 864. The data processor 864 is configured to digitize the data values, store the data values in a memory, and transmit the data values via the transmitter 866 to an external device (e.g., a smart device or a computer), such as the flow controller 850 with the receiver 852. Examples of the water quality parameters include water temperature, pH, conductivity and turbidity, oxidation-reduction potential, total dissolved solids, dissolved oxygen, free chlorine, free arsenic, free cyanide, water flow, blue-green algae concentration, Chlorophyll a concentration, total dissolved gas and specific ion concentration.

Based on the water quality data received from the water analysis system 860, the flow controller 850 may recirculate the treated water from the water storage 870 into the DRIPS 100 for additional treatment. The flow controller 850 may also be configured to control the GAC filter bypass valve 810, electro-chlorinator bypass valve 820, and UV lamp bypass valve 830. The flow controller 850 may bypass the GAC filter 130 for re-chlorinating the treated water using the electro-chlorinator 160 to increase the chlorine residual to improve disinfection, or to bypass the electro-chlorinator 160 and the UV lamp 150 to remove some of the excess chlorine using the GAC filter 130 and the RO unit 140 and make the water more palatable, or to bypass the RO unit 140 and/or the GAC unit 130 for a high quality source water.

In another embodiment, the water quality analysis system 860 may be used to analyze the water from the water source 840 as well. Based on the analysis data, the flow controller 850 can control the GAC filter bypass valve 810, electro-chlorinator bypass valve 820, and UV lamp bypass valve 830 for processing the water from the water source 840.

### Water Purification and Treatment

The DRIPS 100 further provides an adaptable and flexible option for the military as well as non-military users that can be utilized for retrieving source water supplies for production of potable water in times of need and reduces or eliminates the need for appropriated fund requests for bottled water by installations.

The system is adaptable to military grade intake and outtake source water and storage hoses and ancillary accessories to be used as an emerging water treatment unit by the military for installation support and select points beyond the fence.

In one embodiment, the electro-chlorinator 160 is a high concentration bleach generator (as disclosed in U.S. Pat. No. 10,077,197) which is configured to receive a volume of brine into a brine chamber. An electrical power source provides electrical power to an anode electrode and a cathode electrode. An anionic exchange membrane selectively allows passage of negatively charged ions from the brine chamber to the anionic chamber. A cationic exchange membrane selectively allows passage of positively charged ions from the brine chamber to the cationic chamber. The anionic exchange membrane and the cationic exchange membrane may perform their functions simultaneously. A pump conveys a chlorine gas stream from the anionic chamber into the cationic chamber. A hydrogen gas stream diffuses from the high concentration bleach generator through a hydrogen selective membrane. The chlorine gas stream flow and the hydrogen gas stream flow may occur simultaneously. The chlorine gas stream combines with an alkali and alkaline hydroxide mass in the cationic chamber to create a bleach stream.

### Versatility in Water Treatment

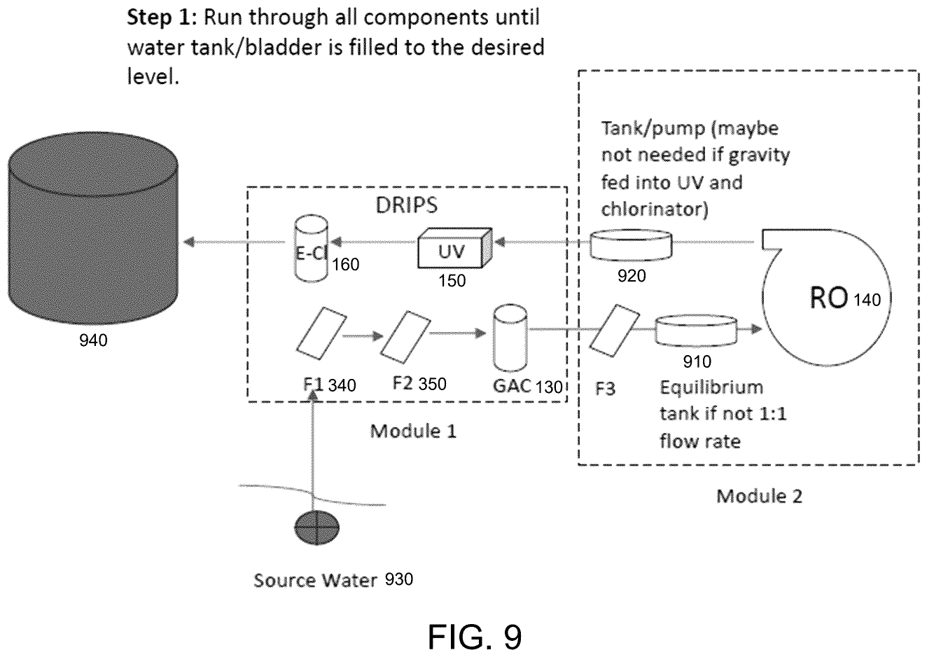

FIG. 9 is a diagram illustrating an example of fluid flow for filling a water tank in the DRIPS to a desired level. The DRIPS 100 in Module 1 includes a first filter F1 (e.g., 100 micron filter 340), a second filter F2 (e.g., 50 micron filter 350), a GAC unit 130, a UV-C disinfection system 150, and an electro-chlorination apparatus 160. Module 2 includes a third filter F3 (e.g., 5 micron filter), an equilibrium tank 910 (if the flow rate is not 1:1), a reverse osmosis (RO) unit 140, and a tank/pump 920 which drives the fluid flow. The tank/pump 920 may not be needed if the water is gravity fed into the UV-C disinfection system 150 and the electro-chlorination apparatus 160.

Water from a water source 930 passes through the filters F1, F2, the GAC unit 130, the filter F3, the equilibrium tank 910 if utilized, the reverse osmosis unit 140, the tank/pump 920 if utilized, the UV-C disinfection system 150, and the electro-chlorination apparatus 160, to a storage tank 940.

A typical reverse osmosis system (RO system) with a GAC pre-filter 130 shows water flowing through a series of stages, including the GAC filter 130, before and after the RO membrane 140. The GAC filter 130 removes chlorine, taste, and odor, while the sediment filters F1, F2 remove particles first. After pre-filtration, water is forced through the semi-permeable RO membrane 140 to remove dissolved impurities. The pre-RO filter F3 can be used prior to the RO process to protect the RO membrane 140 by keeping it clean and reducing the pressure differential. The filter F3 can also increase the RO run time. Post-filtration may include another carbon block and/or a final GAC filter to polish the water before it is stored in a tank. Instead, in this embodiment, the UV-C disinfection system 150 and the electro-chlorination apparatus 160 are utilized to process the water post-filtration prior to storing the processed water in the storage tank 940.

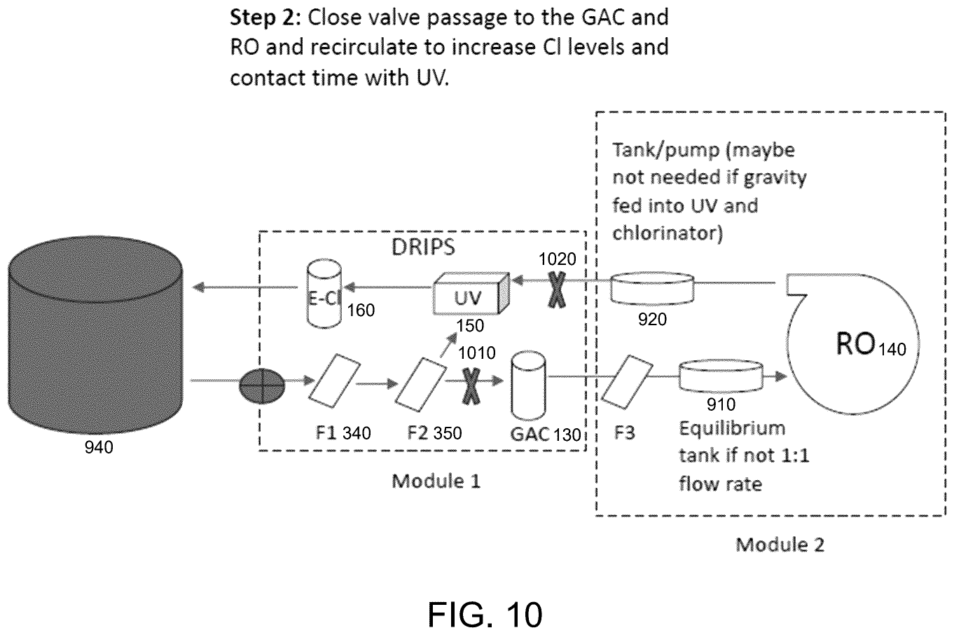

FIG. 10 is a diagram illustrating an example of fluid flow recirculation in the DRIPS to increase Cl levels and contact time with UV. After filling the water tank 940 to a desired level, a first check valve 1010 is used to redirect the flow from the filter F2 to the UV-C disinfection system 150 instead of the GAC unit 130 onto Module 2. A second valve 1020 is used to block the flow from Module 2 to the UV-C disinfection system 150 in Module 1. The first valve 1010 and the second valve 1020 serve as a bypass valve set to bypass the GAC unit 130 and the RO unit 140. Alternatively, the GAC unit 130 may have the GAC filter bypass valve 810 and the first check valve 1010 may be placed between the GAC unit 130 and the RO unit 140 and, together with the second valve 1020, serve as a RO unit bypass valve by directing the flow to the UV lamp 150. The water in the storage tank 940 is recirculated in the DRIPS 100 of Module 1 to increase Cl levels and contact time with UV. The flow controller 850 may be used to control the first valve 1010 and the second valve 1020 as well.

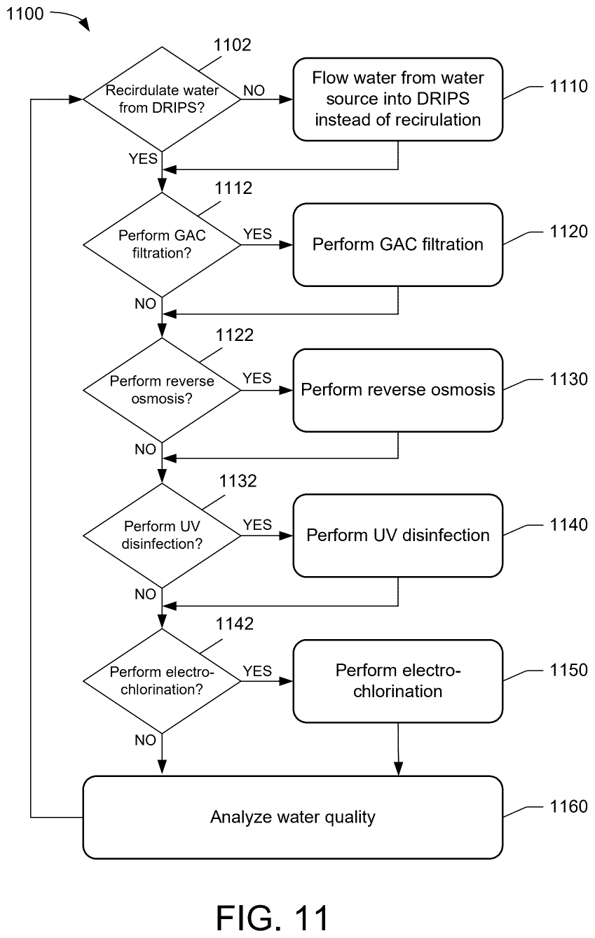

FIG. 11 is a flow diagram 1100 illustrating an example of various processes of operation of the DRIPS 100. Based on data from the water quality analysis system 860, step 1102 determines whether to recirculate the water from the DRIPS 100 back for additional processing in the DRIPS (e.g., to increase Cl levels and contact time with UV). If no, step 1110 flows water from the water source (840 or 930) into the DRIPS 100. If yes, the water is recirculated. Step 1112 determines whether to perform GAC filtration. If yes, step 1120 performs GAC filtration using the GAC unit 130. If no (e.g., high quality water source or water recirculation merely to increase Cl levels and contact time with UV), step 1122 determines whether to perform reverse osmosis. If yes, step 1130 performs reverse osmosis using the RO unit 140. If no (e.g., high quality water source or water recirculation merely to increase Cl levels and contact time with UV), step 1132 determines whether to perform UV disinfection. If yes, step 1140 performs UV disinfection using the UV disinfection system 150. If no (e.g., to bypass the electro-chlorinator 160 and the UV lamp 150 to remove some of the excess chlorine using the GAC filter 130 and the RO unit 140), step 1142 determines whether to perform electro-chlorination. If yes, step 1150 performs electro-chlorination using the electro-chlorination apparatus 160. If no, the method skips step 1150. Next, step 1160 analyses the water quality of the water treated by the DRIPS 100 using the water quality analysis system 860. The water quality analysis system 860 continuously measure multiple parameters of the volume of water flowing therethrough using the water sensor flow cell 862 and continuously transmits data values of the measured parameters via the transmitter 866 to the receiver 852 of the flow controller 850. The data is used in steps 1102, 1112, 1122, 1132, and 1142 to control the water flow using the various valves 810, 820, 830, 1010, and 1020.

The DRIPS technology provides versatility in treatment train(s), power sources, and mobility.

### Versatility in Treatment Train(s)

DRIPS treatment trains versatility includes: treatment for up to ten (10) gallons per minute (10,000 GPD) with reverse osmosis treatment; pre-filtration to reduce suspended solids, such as turbidity, and improvement of disinfection with dual-parallel treatment trains for maintaining operation if one side fouls, clogs, or fails (a single valve operation allows for water diversion for continuous operational needs); a treatment stage with media filtration/adsorption tanks for targeted chemical or radiological containment removal (e.g., granular activated carbon or ion exchange); a UV-C LED for additional microbial inactivation; an on-site chloride dioxide gas and bleach generation for disinfection (utilizing sodium chloride salt, for example) (electro-chlorination); and an ability to add or subtract treatment processes during field operation and an ability to recirculate treated water to increase disinfection or decrease chlorination concentrations, as needed.

### Versatility in Power Source(s)

DRIPS power source versatility includes: military-provided generator(s); dual fuel generator standard (propane, gasoline); operability with military fuels/JP-8/F-24; 110 VAC (indoor/outdoor) or 220 VAC, based on configuration; grouped unique military-grade lithium-ion battery startup kit with vehicular panel NATO standard recharge cable; and compatibility with 24 VDC NATO vehicle power.

### Versatility in Mobility

DRIPS mobility versatility includes: weight of approximately 2,000 lbs.; ruggedized construction; ramp feature for on- and off-loading at point of use; system retrofit as a two-tiered unit within a tactical trailer; and 8- to 10-person material handling for system transport.

The invention presents an effective solution for a compact and ruggedized system for water purification and treatment as improvements to and/or utilization of U.S. Pat. Nos. 10,077,197 and 10,288,595. Further, the invention allows the integration of military-equivalent fittings, gauges, meters, and communications.

The inventive concepts taught by way of the examples discussed above are amenable to modification, rearrangement, and embodiment in several ways. Accordingly, although the present disclosure has been described with reference to specific embodiments and examples, persons skilled in the art will recognize that changes may be made in form and detail without departing from the spirit and scope of the disclosure.

An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

Embodiments of the invention can be manifest in the form of methods and apparatuses for practicing those methods. The benefits of implementing this technology include the ability to add or subtract treatment processes during field operation and an ability to recirculate treated water to increase disinfection or decrease chlorination concentrations, as needed, as well as the ability to operate the compact and ruggedized water purification and treatment system under multiple optional power sources.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A deployable water treatment system configured to be placed on a mobile trailer for treating water, the system comprising:
a UV-C disinfection system to apply ultraviolet (UV) light to the water;
an electro-chlorination apparatus using electricity to convert the water into a sodium hypochlorite solution;
particulate filtration modules for particulate filtration of the water;
a granular activated carbon (GAC) filtration device to filter the water; and
a water quality analysis system including a water sensor flow cell having sensors to measure water quality parameters of the water to produce data, a data processor to digitize the data for the water quality parameters, and a transmitter to transmit the data from the data processor to a flow controller to be used to control a flow of the water to recirculate the water though the deployable water treatment system or not.

2. The deployable water treatment system of claim 1,
wherein the sensors are configured to continuously measure the water quality parameters of the water and continuously transmit the data of the measured water quality parameters to the data processor.

3. The deployable water treatment system of claim 1,
wherein the water quality parameters include two or more of water temperature, pH, conductivity and turbidity, oxidation-reduction potential, total dissolved solids, dissolved oxygen, free chlorine, free arsenic, free cyanide, water flow, blue-green algae concentration, Chlorophyll a concentration, total dissolved gas and specific ion concentration.

4. The deployable water treatment system of claim 1, further comprising:
dual infusion pumps to provide parallel paths filtration of the water through the particulate filtration modules;
wherein the particulate filtration modules comprise individual, self-contained filters that are linked together to form a flexible and scalable filtration system.

5. The deployable water treatment system of claim 1, further comprising:
a UV-C disinfection bypass valve to bypass the UV-C disinfection system; and
an electro-chlorination bypass valve to bypass the electro-chlorination apparatus;
wherein the data transmitted to the flow controller is used to control the flow of the water to bypass the UV-C disinfection system via the UV-C disinfection bypass valve or not and to bypass the electro-chlorination apparatus via the electro-chlorination bypass valve or not.

6. The deployable water treatment system of claim 1, further comprising:
a GAC filtration bypass valve to bypass the GAC filtration device;
wherein the data transmitted to the flow controller is used to control the flow of the water to bypass the GAC filtration device via the GAC filtration bypass valve or not.

7. The deployable water treatment system of claim 1, further comprising:
a reverse osmosis (RO) system to perform reverse osmosis of the water; and
a GAC filtration and RO system bypass valve to bypass the GAC filtration device and the RO system;
wherein the data transmitted to the flow controller is used to control the flow of the water to bypass the GAC filtration device and the RO system via the GAC filtration and RO system bypass valve or not.

8. The deployable water treatment system of claim 1, further comprising:
an inverter battery system including a battery bank, a charge controller, and an inverter configured to receive AC input from an AC source and to receive DC input via the charge controller and the battery bank to the inverter.

9. A deployable water treatment system for treating water, the system comprising:
a trailer bed;
a water treatment system disposed in the trailer bed, the water treatment system including a UV-C disinfection system to apply ultraviolet (UV) light to the water; an electro-chlorination apparatus using electricity to convert the water into a sodium hypochlorite solution;
particulate filtration modules for particulate filtration of the water; and a granular activated carbon (GAC) filtration device to filter the water; and
a water quality analysis system disposed in the trailer bed, the water quality analysis system including a water sensor flow cell having sensors to measure water quality parameters of the water to produce data, a data processor to digitize the data for the water quality parameters, and a transmitter to transmit the data from the data processor to a flow controller to be used to control a flow of the water to recirculate the water though the deployable water treatment system or not.

10. The deployable water treatment system of claim 9,
wherein the water treatment system further comprises dual infusion pumps to provide parallel paths filtration of the water through the particulate filtration modules; and
wherein the particulate filtration modules comprise individual, self-contained filters that are linked together to form a flexible and scalable filtration system.

11. The deployable water treatment system of claim 9,
wherein the water treatment system further comprises a UV-C disinfection bypass valve to bypass the UV-C disinfection system and an electro-chlorination bypass valve to bypass the electro-chlorination apparatus; and
wherein the flow controller is disposed in the trailer bed to use the data transmitted to the flow controller to control the flow of the water to bypass the UV-C disinfection system via the UV-C disinfection bypass valve or not and to bypass the electro-chlorination apparatus via the electro-chlorination bypass valve or not.

12. The deployable water treatment system of claim 9,
wherein the water treatment system further comprises a GAC filtration bypass valve to bypass the GAC filtration device; and
wherein the flow controller is disposed in the trailer bed to use the data transmitted to the flow controller to control the flow of the water to bypass the GAC filtration device via the GAC filtration bypass valve or not.

13. The deployable water treatment system of claim 9,
wherein the water treatment system further comprises a reverse osmosis (RO) system to perform reverse osmosis of the water and a GAC filtration and RO system bypass valve to bypass the GAC filtration device and the RO system; and
wherein the flow controller is disposed in the trailer bed to use the data transmitted to the flow controller to control the flow of the water to bypass the GAC filtration device and the RO system via the GAC filtration and RO system bypass valve or not.

14. A method comprising:
placing a water treatment system and a water quality analysis system in a trailer bed;
directing a flow of the water into the water treatment system, which includes a UV-C disinfection system to apply ultraviolet (UV) light to the water; an electro-chlorination apparatus using electricity to convert the water into a sodium hypochlorite solution; particulate filtration modules for particulate filtration of the water; and a granular activated carbon (GAC) filtration device to filter the water;
analyzing a water quality of the water exiting the water treatment system to measure water quality parameters of the water to produce data, to digitize the data for the water quality parameters using a data processor, and to transmit the data from the data processor to a flow controller; and
determining, based on the data transmitted to the flow controller, whether to recirculate the water exiting the water treatment system into the water treatment system for additional treatment or to direct water from a water source into the water treatment system for treatment.

15. The method of claim 14, wherein analyzing the water quality comprises:
continuously measuring the water quality parameters of the water and continuously transmitting the data of the measured water quality parameters to the data processor.

16. The method of claim 14, wherein analyzing the water quality comprises:
measuring the water quality parameters which include two or more of water temperature, pH, conductivity and turbidity, oxidation-reduction potential, total dissolved solids, dissolved oxygen, free chlorine, free arsenic, free cyanide, water flow, blue-green algae concentration, Chlorophyll a concentration, total dissolved gas and specific ion concentration.

17. The method of claim 14, wherein directing the flow of water into the water treatment system comprises:
using dual infusion pumps to provide parallel paths filtration of the water through the particulate filtration modules.

18. The method of claim 14, further comprising using the data transmitted to the flow controller to control the flow of the water through the water treatment system, which includes:
determining whether to bypass the UV-C disinfection system via a UV-C disinfection bypass valve;
determining whether to bypass the electro-chlorination apparatus via an electro-chlorination bypass valve; and
determining whether to bypass the GAC filtration device via a GAC filtration bypass valve.

19. The method of claim 14, wherein the water treatment system further includes a reverse osmosis (RO) system to perform reverse osmosis of the water; the method further comprising using the data transmitted to the flow controller to control the flow of the water through the water treatment system, which includes:
determining whether to bypass the UV-C disinfection system via a UV-C disinfection bypass valve;
determining whether to bypass the electro-chlorination apparatus via an electro-chlorination bypass valve; and
determining whether to bypass the GAC filtration device and the RO system via a GAC filtration and RO system bypass valve.

20. The method of claim 14, further comprising:
supplying AC to operate the water treatment system and the water quality analysis system using an inverter battery system disposed in the trailer bed, the inverter battery system including a battery bank, a charge controller, and an inverter configured to receive AC input from an AC source and to receive DC input via the charge controller and the battery bank to the inverter.
